(19) United States
(12) Patent Application Publication
(10) Pub. No.: US 2022/0039133 A1
(43) Pub. Date: Feb. 3, 2022

(54) CENTRALIZED INTERCELL INTERFERENCE COORDINATION

(71) Applicant: Nokia Technologies Oy, Espoo (FI)

(72) Inventors: Ingo VIERING, Munich (DE); Klaus Ingemann PEDERSEN, Aalborg (DK); Guillermo POCOVI, Aalborg (DK)

(21) Appl. No.: 17/276,521

(22) PCT Filed: Sep. 18, 2018
(86) PCT No.: PCT/EP2018/075177

§ 371 Date: Mar. 16, 2021

(51) Int. Cl. H04W 72/12; H04L 5/00; H04W 28/02; H04W 28/16

(52) U.S. Cl. CPC H04W 72/1278; H04L 5/0032; H04W 28/16; H04W 72/1231; H04W 28/0236

(57) ABSTRACT

It is provided a method, comprising monitoring if a first cell receives one or more scheduling mode indications including a first scheduling mode indication for at least one of a downlink transmission of the first cell and an uplink transmission to the first cell, wherein the first scheduling mode indication comprises forbidding to schedule a respective resource for the at least one of the downlink transmission and the uplink transmission; and the method further comprises forbidding, for the first scheduling mode indication, a scheduler of the first cell to schedule the respective resource for the at least one of the downlink transmission and the uplink transmission if the one or more scheduling mode indications are received.

### FIELD OF THE INVENTION

The present invention relates to intercell interference coordination (ICIC), or rather mitigation.

### Abbreviations

3GPP 3^{rd} Generation Partnership Project
4G/5G 4^{th}/5^{th} Generation
BS Base Station
CHS CoMP Hypothesis Set
CoMP Cooperative Multi Point
CQI Channel Quality Indicator
CSI Channel State Information
CU Central Unit
CU-CP Central Unit—Control Plane
CU-UP Central Unit—User Plane
CSI-RS CSI Reference Signal
DL Downlink
DU Distributed Unit
ECGI E-UTRAN Cell Global Identifier
eCOMP enhanced COMP
eICIC enhanced Intercell Interference Coordination
gNB Base Station in 5G/NR
HetNet Heterogeneous Network
HII High Interference Indicator
ICIC Intercell Interference Coordination
ID Identity
LTE Long Term Evolution
MAC Medium Access Control
NR New Radio (air interface standard of 5G systems)
OAM Operation and Maintenance
OFDM Orthogonal Frequency Division Multiplex
OI Overload Indicator
PDCP Packet Data Convergence Protocol
PRB Physical Resource Block
QCI QoS Class Indicator
QoS Quality of Service
RAN Radio Access Network
Rel Release
RF Radio Frequency
RLC Radio Link Control
RNTP Relative Narrowband Transmit Power
RRC Radio Resource Control
RSRP Reference Signal Received Power
SDAP Service Data Adaptation Protocol
SINR Signal to interference and noise ratio
SPM Scheduler Preference Matrix
SRM Scheduler Restriction Matrix
TDD Time Division Duplex
TS Technical Specification
UE User Equipment
UL Uplink

### BACKGROUND OF THE INVENTION

In a loaded cellular system, intercell interference often massively limits capacity, since operators want to reuse the expensive spectrum in every cell.

FIG. 1 shows an example network with some UEs (users) served by the networks. The network comprises cell 1 and cell 40. Both have cell edge users 17, 47 and cell center users 18, 48. Cell edge users are located close to the edge of the respective serving cell, while cell center users are more remote from the edge.

A) Downlink

In downlink, without coordination, the cell edge users 17 in cell 1 will have poor SINR, since they get strong interference from the neighboring base stations, in particular from cell 40. The idea of interference coordination is that the SINR of the cell edge users 17 in cell 1 can be massively improved when cell 40 protects their resources. “Protection” means using either reduced power, or not using the resources at all (“blanking”).

Only the resources of the cell edge users may be protected, the resources of the cell center users don't need protection, as the SINR is good anyway. Even on the cell edge, not necessarily every UE has to be protected, depending on its required QoS.

Such a protection requires that the base stations exchange information.
Cell 40 should know that it has to protect resources, and how many (and potentially which ones). This information may be retrieved from cell 1.
Cell 1 should know which resources are protected by cell 40 such that it can schedule users on the cell-40 edge on those resources. This information may be retrieved from cell 40.

Unfortunately, cell 40 will not only receive coordination information from cell 1, but also from some or all its other neighbors. Furthermore, it also has to schedule its own cell edge users based on the protected resources signalled by its neighbors.

A) Uplink

The situation in uplink is similar, but it shows some differences, mainly due to the power control applied to the uplink transmission of the terminal. The SINRs (at the gbase station) are quite similar for cell edge users and cell center users, since the power control compensates the pathloss. Without coordination, the cell edge users in cell 40 close to the cell edge to cell 1 may produce massive interference to many users in cell 1 because of their larger transmit power (compared to the transmit power of cell center users of cell 40) and because they are closer to cell 1 than the cell center users in the center of cell 40. Fractional power control and users in power limitation still would make cell edge users in cell 1 suffer more. Therefore, control of the uplink resources used by the cell edge users is crucial for mitigating inter-cell interference.

So similar to the downlink, the resources of the cell edge users in cell 1 should be interference protected. However, “protection” in uplink does not necessarily mean that cell 40 shall use blanking, but it may mean that cell 40 schedules these resources for its center users. Those are farther away from the cell-1-antenna, and they use smaller power due to power control. Thus, they may not cause significant interference to cell-1 users.

We also would like to highlight another difference between uplink and downlink. In downlink, cell 1 will create harm to all cell boundaries, when transmitting (this is true when no beamforming is used, the beamforming case is discussed below). I.e. when ANY of the neighboring cells asks for interference protected resources, cell 1 has to blank (or reduce the power) in general. So scheduler restrictions for interference protection would be cell-specific in uplink, but would not be cell-specific in downlink (unless beamforming is used)

In uplink, the interference is produced by the terminals. In FIG. 1, cell 1 produces intercell interference only for cell 40 and not for the other cells (e.g. cell 21). So, if e.g. cell 21 would ask for protected resources, the cell center UEs 18 in cell 1 can still be scheduled although they are on the cell edge, since they don't harm cell 21.

This may lead to a deviating uplink solution as will be discussed later on. This is also a reason, why Rel14 eCoMP only specifies a downlink solution. A similar solution for the uplink is still an open problem.

Centralized Architecture

For New Radio, a centralized architecture has been defined. FIG. 2 shows a simplified figure of the centralized architecture. A (logical) gNB is split into a central unit (CU) and a distributed unit (DU). The fronthaul split interface F1 is specified in 3GPP TS 38.473 between the PDCP and the RLC layer. RRC is also located in the CU. Each DU corresponds to today's base station sites (i.e., the meaning of the term “NodeB” in former releases is slightly different from that according to New Radio), and may serve multiple cells (represented by plural RF). The scheduling is done in the MAC layer located in the DU, since this has to be close to the radio. The CU might be implemented in a cloud, and contains PDCP and RRC. A single CU may serve one or more DUs.

The interface F1 is non-ideal. I.e., it operates with a non-zero/non-negligible delay on the interface. If the delay were negligible, all the scheduler decisions could be done in the central unit, which could act as one single centralized scheduler. However, due to the non-negligible delay, a centralized coordination in CU and distributed schedulers in DUs are implemented. FIG. 3 shows two (logical) gNBs which are connected by an Xn interface, just as in LTE (in LTE: X2 interface). However, the left gNB is subdivided into CU and DUs as discussed above. Note that there is no interface between the DUs, the Xn interface connects the CUs of the logical gNBs.

Furthermore, the CUs can be split into a control plane part (CU-CP) containing the RRC, and a user plane part (CU-UP) containing the SDAP. This split involves another interface named E1 newly introduced for NR.

Flexible Frame Structure

Whereas LTE supports only 8 predefined TDD frame structures, NR supports a very large number of slot structures.

The 5G NR frame structure is designed to be highly flexible. A radio frame is 10 ms, and consists of a series of 1 ms subframes. Each frame is divided into two equally-sized half-frames of five subframes, each with half-frame 0 consisting of subframes 0-4 and half-frame 1 consisting of subframes 5-9. A subframe consists of 14 OFDM symbols for cases with normal cyclic prefix, while it consists of only 12 OFDM symbols for the case with extended cyclic prefix and subcarrier spacing of 60 kHz. The number of slots per subframe/radio frame depends on the subcarrier spacing. For 15 kHz subcarrier spacing there is one slot per subframe, for 30 kHz subcarrier spacing there are two slots per subframe, for 60 kHz subcarrier spacing there are four slots per subframe, and so forth. Mini-slots, consisting of shortened resource allocations of 1 to 13 OFDM symbols are also defined.

A larger number of possible slot formats are defined in FIG. 4 (source: 3GPP TS 38.211—Table 4.3.2-3), where “D” indicates downlink symbol, “U” indicates uplink symbol, and “X” is flexible. Hence, “X” could refer to muting or be used for downlink or uplink transmission. As an example, slot format 0 and 1 corresponds to downlink-only and uplink-only slots, respectively. Slot format 36 contains first three downlink transmission symbols, followed by “X” (which could be set to mute for guard period), and ten uplink transmissions. Slot format 16 contains a first downlink symbol, and the 13 remaining symbols are flexible; slot format 8 contains a last uplink symbol, and the 13 remaining symbols are flexible. The latter two ones are the most flexible slot formats and may be used for dynamic TDD schemes, where the scheduler is able to decide in real-time whether to use symbols for uplink or for downlink.

Beamforming

Finally, NR may make vast use of beamforming, at both higher frequencies (above 6 GHz, typically around 28 GHz) and lower frequencies (below 6 GHz). This offers further degrees of freedom for interference coordination, since the interference is directional in this case. Furthermore, in many implementations (in particular at higher frequencies), the beams in one cell cannot be used simultaneously due to hardware constraints (analogue/hybrid beamforming). In such a case, at a given point in time, a base station does not produce interference into all directions anyway; this may reduce the price for coordination compared with conventional blanking methods, since blanking always means a bandwidth investment.

Several interference coordination methods have been specified for LTE by 3GPP:

Release 8 OI, HII, RNTP

Release 8 LTE foresees frequency domain ICIC: the X2 specification 36.423 specifies Overload Indicator (OI) and High Interference Indicator (HII) for uplink ICIC, and Relative Narrowband Transmit Power (RNTP) for the downlink. However, all those methods are distributed methods. The cells either send measurements (OI), or they inform the neighbour cells about an own strategy (HII, RNTP). They cannot force a certain behaviour of neighbour cells, so their potential is limited. Furthermore, they are obviously not suitable for the flexible uplink and downlink decision as they are specified in NR.

Release 10 eICIC

Release 10 has introduced Enhanced ICIC (elCIC), also called time domain eICIC. Still, it is a distributed method. In contrast to the Rel8 methods, it only allows for time domain coordination, frequency coordination is not possible (which massively limits its potential for the general coordination. Note that it was designed especially for the HetNet case, where small cells typically have exactly one macro neighbour (or at least a very small number), whereas typical cells in NR will have a lot of (>10) neighbors on the same hierarchical level.

Release 14 Inter-eNB CoMP (“eCoMP”)

eCoMP offers both, time and frequency domain coordination capability. During the 3GPP discussions, centralized solutions have been discussed, but the specified solution is a distributed solution again. A centralized implementation is explicitly possible and allowed. The specified information exchange is still assumed to be between elements of the same hierarchical level (i.e. eNBs), so a desired behaviour cannot be forced. I.e., an eNB can never rely on a certain reaction in the peer entity.

Furthermore, eCoMP only provides downlink coordination, and does not address the directional beam domain (just as elCIC and Rel8 ICIC).

### SUMMARY OF THE INVENTION

It is an object of the present invention to improve the prior art.

According to a first aspect of the invention, there is provided an apparatus, comprising means for monitoring configured to monitor if a first cell receives one or more scheduling mode indications including a first scheduling mode indication for at least one of a downlink transmission of the first cell and an uplink transmission to the first cell, wherein the first scheduling mode indication comprises forbidding to schedule a respective resource for the at least one of the downlink transmission and the uplink transmission; and the apparatus further comprises means for forbidding configured to forbid, for the first scheduling mode indication, a scheduler of the first cell to schedule the respective resource for the at least one of the downlink transmission and the uplink transmission if the one or more scheduling mode indications are received.

According to a second aspect of the invention, there is provided an apparatus, comprising means for monitoring configured to monitor if a first cell receives one or more scheduling mode indications for at least one of a downlink transmission of the first cell and an uplink transmission to the first cell, wherein each of the one or more scheduling mode indications comprise allowing to schedule a respective resource for the at least one of the downlink transmission and the uplink transmission; and the apparatus further comprises means for checking configured to check if at least one of the one or more scheduling mode indications allows to schedule a first resource for the at least one of the downlink transmission and the uplink transmission if the first cell receives the one or more scheduling mode indications; means for forbidding configured to forbid a scheduler of the first cell to schedule the first resource for the at least one of the downlink transmission and the uplink transmission if none of the one or more scheduling mode indications allows to schedule the first resource for the at least one of the downlink transmission and the uplink transmission.

According to a third aspect of the invention, there is provided an apparatus, comprising means for obtaining configured to obtain for each of one or more cells for at least a respective one of a downlink transmission of the respective cell and an uplink transmission to the respective cell respective one or more scheduling mode indications including a respective first scheduling mode indication; wherein each of the first scheduling mode indications comprises either forbidding or allowing to schedule a respective resource for the at least one of the downlink transmission of the respective cell and the uplink transmission to the respective cell; and the apparatus further comprises means for transmitting configured to transmit, for each of the one or more cells, the respective one or more scheduling mode indications to the respective cell.

According to a fourth aspect of the invention, there is provided a method, comprising monitoring if a first cell receives one or more scheduling mode indications including a first scheduling mode indication for at least one of a downlink transmission of the first cell and an uplink transmission to the first cell, wherein the first scheduling mode indication comprises forbidding to schedule a respective resource for the at least one of the downlink transmission and the uplink transmission; and the method further comprises forbidding, for the first scheduling mode indication, a scheduler of the first cell to schedule the respective resource for the at least one of the downlink transmission and the uplink transmission if the one or more scheduling mode indications are received.

According to a fifth aspect of the invention, there is provided a method, comprising monitoring if a first cell receives one or more scheduling mode indications for at least one of a downlink transmission of the first cell and an uplink transmission to the first cell, wherein each of the one or more scheduling mode indications comprise allowing to schedule a respective resource for the at least one of the downlink transmission and the uplink transmission; and the method further comprises checking if at least one of the one or more scheduling mode indications allows to schedule a first resource for the at least one of the downlink transmission and the uplink transmission if the first cell receives the one or more scheduling mode indications; forbidding a scheduler of the first cell to schedule the first resource for the at least one of the downlink transmission and the uplink transmission if none of the one or more scheduling mode indications allows to schedule the first resource for the at least one of the downlink transmission and the uplink transmission.

According to a sixth aspect of the invention, there is provided a method, comprising obtaining for each of one or more cells for at least a respective one of a downlink transmission of the respective cell and an uplink transmission to the respective cell respective one or more scheduling mode indications including a respective first scheduling mode indication; wherein each of the first scheduling mode indications comprises either forbidding or allowing to schedule a respective resource for the at least one of the downlink transmission of the respective cell and the uplink transmission to the respective cell; and the method further comprises transmitting, for each of the one or more cells, the respective one or more scheduling mode indications to the respective cell.

Each of the methods of the fourth to sixth aspects may be a method of intercell interference coordination.

According to a seventh aspect of the invention, there is provided a computer program product comprising a set of instructions which, when executed on an apparatus, is configured to cause the apparatus to carry out the method according to any of the fourth to sixth aspects. The computer program product may be embodied as a computer-readable medium or directly loadable into a computer.

According to some example embodiments of the invention, at least one of the following advantages may be achieved:
effective intercell interference mitigation;
works with the flexible frame structure of NR
Simple Signaling (and scalable), easy to specify.
Some paradigms from eCoMP are reused.
Maximal flexibility. It allows a wide range of ICIC methods, from extremely simple ones (just based on blanking) up to very elaborated ones. In particular it
   allows both uplink and downlink interference coordination,
   allows coordination of TDD interference (UE-UE and BS-BS)
   allows beam coordination
It fully exploits the centralized nature, i.e. a method tailored to the centralized architecture will converge much better, in particular when there are many constraints, and many degrees of freedom (in the beamforming case).
It leaves a lot of space for vendor specific implementation in both:
   Central Unit (to make elaborate coordination decisions)
   Distributed Unit (to realize the received constraints in the scheduler implementation).

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred example embodiments of the present invention which is to be taken in conjunction with the appended drawings, wherein:

FIG. 1 shows an example network with interference coordination according to the prior art;

FIG. 2 shows a simplified figure of the centralized architecture of New radio;

FIG. 3 shows two (logical) gNB connected via Xn interface;

FIG. 4 shows Table 4.3.2-3 of 3GPP TS 38.211;

FIG. 5 depicts step 1 of a procedure according to an example embodiment of the invention;

FIG. 6 depicts step 2 of a procedure according to an example embodiment of the invention;

FIG. 7 shows an example to protect the downlink according to some example embodiments of the invention;

FIG. 8 shows an example to protect the uplink according to some example embodiments of the invention;

FIG. 9 shows a signalling option 1 according to some example embodiments of the invention;

FIG. 10 shows a signalling option 2 according to some example embodiments of the invention;

FIG. 11 shows an apparatus according to an example embodiment of the invention;

FIG. 12 shows a method according to an example embodiment of the invention;

FIG. 13 shows an apparatus according to an example embodiment of the invention;

FIG. 14 shows a method according to an example embodiment of the invention;

FIG. 15 shows an apparatus according to an example embodiment of the invention;

FIG. 16 shows a method according to an example embodiment of the invention; and

FIG. 17 shows an apparatus according to an example embodiment of the invention;

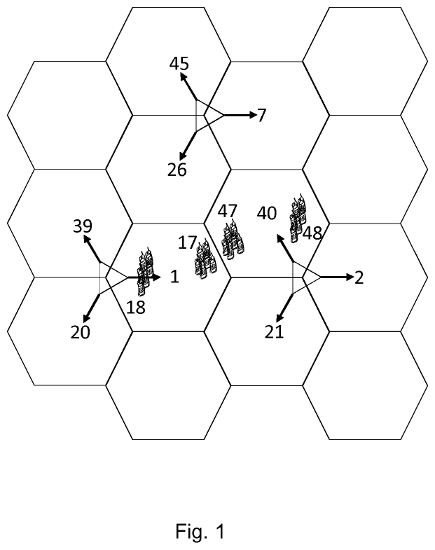

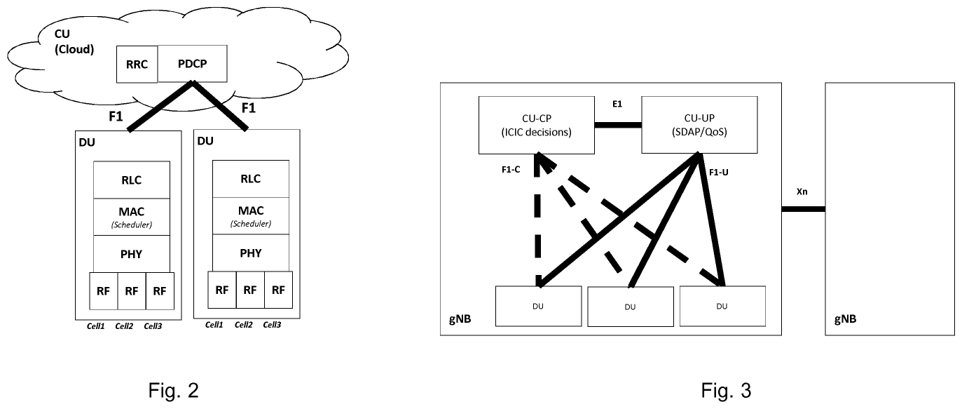

### DETAILED DESCRIPTION OF CERTAIN EXAMPLE EMBODIMENTS

Herein below, certain example embodiments of the present invention are described in detail with reference to the accompanying drawings, wherein the features of the example embodiments can be freely combined with each other unless otherwise described. However, it is to be expressly understood that the description of certain example embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

Some example embodiments of the invention address intercell interference coordination (ICIC) in a cellular communication system such as LTE or 5G/New Radio. More specifically, some example embodiments of the invention address a cellular communication system featuring a centralized architecture such as New Radio (NR), where interference coordination can be done (or even has to be done) in a centralized manner. In some example embodiments of the invention, beamforming is considered, too.

The centralized architecture of NR may be exploited for intercell interference coordination. On one hand, CU-CP seems to be an ideal place to do a centralized interference coordination for the following reasons:
The RRC typically has (or can get) detailed knowledge about how close the users are to which edge (see the explanation of RF fingerprinting below).
CU-CP is responsible for many DUs, has central knowledge about the users in many DUs, and thus can coordinate a large area.

On the other hand, new problems have to be solved if CU-CP performs centralized interference coordination:
Coordination decisions made in the CU-CP have to be brought to the schedulers located in the DUs via F1-C interface.
QoS knowledge is particularly useful for the coordination decisions. The coordinator in CU-CP should know how “heavy” the users are. This information may be retrieved from the CU-UP via E1 interface.
More detailed radio information via F1-C interface might be useful.

The huge flexibility of the slot formats in NR should be taken into account when deciding and signalling ICIC in the CU as well. In particular, since flexible slots/subframes did not exist in LTE, this degree of freedom was not available for the scheduler.

Furthermore, those slot formats have been specified only in RAN1. Adaptation of slot formats allows the system to operate in line with offered traffic conditions. The slot format selection shall also be performed not to create too much cross-link interference. The CU is therefore in the best position to determine slot format selections (and as a consequence the used radio frame configuration) for the different cells. However, for the centralized CU-DU architecture, it is currently not clear how those will reach the MAC scheduler. OAM will configure the CU(-CP), and the most likely, a later version of the specification of the F1-C interface (currently defined in 3GPP TS 38.473) will specify how the CU takes those slot formats to the DU.

In this case, the DU will have the freedom to decide how to use the flexible slots “X”. Interference coordination should make sure that this flexibility does not lead to massive conflicts (while still leaving some flexibility).

Interference coordination in NR may take into account the beam domain, too, thereby allowing beam coordination as well.

The prior art offers distributed solutions to intercell interference coordination. In general, distributed solutions have convergence problems, if there are too many constraints and coordination requests. Although the distributed solutions might be applied to a centralized case, tailoring a centralized solution may leverage much more benefits.

Furthermore, none of the prior art methods addresses Uplink [symbol] Downlink cross-link interference (i.e. UE to UE) and Downlink [symbol] Uplink cross-link interference (i.e. BS to BS) which may occur in TDD systems when different slot structures and/or flexible slots are allowed in neighboring cells.

According to some example embodiments of the invention, the CU (or CU-CP, respectively) will make central ICIC decisions based on its knowledge, and signals the resulting scheduling restrictions or preferences (hereinafter sometimes summarized as scheduling mode indications) to the connected DUs via the F1-C interface. Preferably, the scheduling mode indications are provided separately on the F1-C interface for each cell served by the DU.

More precisely, the scheduler restrictions may comprise an instruction per frequency chunk (e.g. physical resource block PRB), and potentially per recurring time instance. The instructions shall force the MAC scheduler responsible for the cell to apply at least one of the following constraints to the affected time/frequency resource:
No Uplink transmission at all
No Downlink transmission at all

In addition, more elaborate scheduler restrictions may be signaled per boundary between the receiving cell A and its neighbor B (i.e. per cell neighbor). These would lead to less strict constraints for the cell scheduler. For example, CU may provide one of the following scheduler constraints:
No uplink transmissions of UEs which are close to boundary towards cell B only or a portion thereof
No downlink transmissions towards the direction of boundary towards cell B only or a portion thereof
No downlink transmission towards the direction of the base station serving the cell B

For the sake of completeness, CU may signal that there is no constraint on a certain resource, or that a certain resource is preferred for scheduling.

Whereas the scheduler restrictions are signaled to the aggressors, it is advantageous when the CU-CP informs the victim about the time/frequency resources which are protected from a certain type of interference. The scheduler may use this information to schedule the corresponding UEs. In some cases, providing information on protected resources may not be necessary, since the UE would inherently feedback better CQIs on those resources for the corresponding users, such that a smart scheduler would automatically prefer those resources for the respective user.

As mentioned above, CU-CP hosts the RRC and thereby already has quite some knowledge to decide the constraints listed above. However, this knowledge may be further extended by retrieving
Further radio information from the DU via F1-C interface such as CSI information (e.g. CQI), potentially averaged over frequency and/or time, uplink interference measurements per frequency, or per time, etc.
QoS information from the CU-UP via E1 interface, including Buffer Status Information in downlink and/or Buffer Status Reports in uplink and Throughput measurements from the past

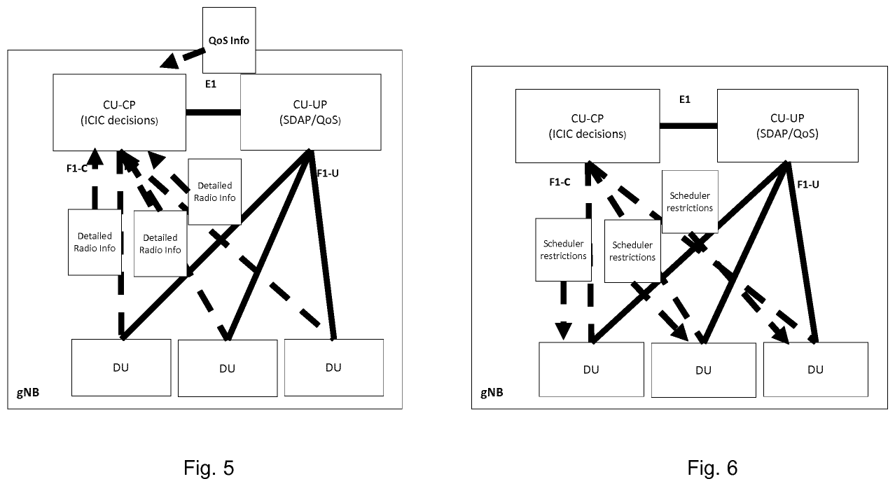

A procedure according to some example embodiments of the invention may comprise 2 steps. In an optional step 1 (cf. FIG. 5), the coordination entity making the ICIC decisions (CU-CP) collects information via the interfaces E1 and F1-C to make better decisions. This step is not essential for the invention because the CU-CP already has sufficient information, in particular from RRC.

Based on the available information (internally available RRC information, plus the optional additional information via E1 and F1-C), the ICIC decision is made inside the CU-CP. In a second step (FIG. 6), the decision is signalled to the DUs to be considered in their scheduler decisions.

In the following, two examples are given how the decisions can be made, one for downlink protection, and one for uplink protection.

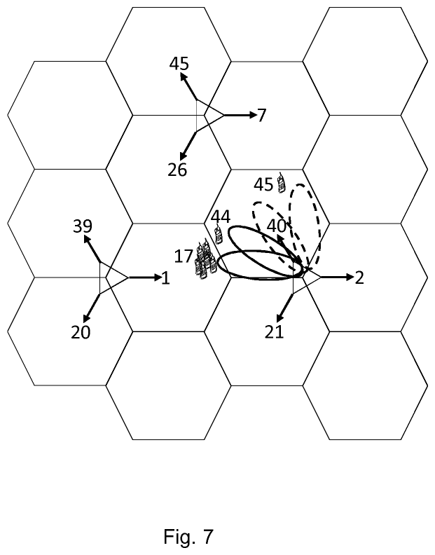

FIG. 7 shows an example to protect the downlink of the cell edge users 17 in cell 1 from intercell interference. It is assumed that the RRC has enough information to understand whether a certain UE is in a cell center, or whether it is on a certain boundary (via RF fingerprinting by RSRP). In “RF fingerprinting”, the location of a UE is estimated based on RF measurements. For example: a UE is connected to cell A. If it measures that the signal strength (RSRP) of cell B is as strong as that of cell A, but it does not measure any other cell with significant signal strength, one may conclude that the UE is at the boundary between cells A and B, and far away from other boundaries. If the UE measures the signal strength of cell B and cell C as strong as that of cell A (and no other cell with significant signal strength), one may conclude that the UE is at a corner between cells A, B and C. If the UE measures the signal strength of cell B as strong as that of cell A, and the signal strength of cell C is only a bit weaker, one may conclude that the UE is on the boundary towards B, but also close to cell C.

Furthermore, it is assumed that interference for the downlink may be created by the downlink of other cells (i.e. by neighboring base stations), as well as by the uplink of other cells (i.e. by UEs in neighboring cells). Note that this is a consequence of not using the same TDD patterns in the cells, and/or of allowing flexible slots “X”.

In a first step, the CU-CP identifies a set of one or more time/frequency resources for whom the downlink should be interference-protected. Later on, downlink transmissions to the cell edge users 17 (on the cell boundary of cell 1 to cell 40) will be scheduled on these resources.

In a second step, the CU-CP identifies the neighboring cells who are responsible for the interference (which can be taken from RSRP reports). In the example, this would be mainly cell 40. Potentially, cell 21 and 26 may also be identified.

Finally, the CU-CP can decide the following scheduler restrictions for the identified time/frequency resources:
D1: Cell 40 shall not use the downlink at all (neither the beams indicated by solid lines nor the beams indicated by broken lines in FIG. 7);
D2: Cell 40 shall not use the uplink at all (neither UEs 44 on the cell edge of cell 40 towards cell 1 nor UEs 45 at distance from the cell edge of cell 40 towards cell 1, e.g. in the center of cell 40).

Those scheduler restrictions (constraints) D1 and D2 could be pretty strict. One may argue that the UE 45 may send the uplink, or the base stations may send out the beams indicated by broken lines, since both will have limited impact on the interference of the cell edge users 17 of cell 1. So one may refine the scheduler restrictions for the identified time/frequency resources to the more relaxed scheduler restrictions D3 and D4:
D3: Cell 40 shall not transmit beams towards the boundary to cell 1 (beams indicated by solid lines are forbidden but beams indicated by broken lines in FIG. 7 are allowed);
D4: Cell 40 shall not schedule any uplink transmission of UEs (such as UE 44) which are close to the boundary to cell 1.

The CU-CP may also decide scheduler restrictions for cells 26 and 21. These would follow the same principles and logics as above.

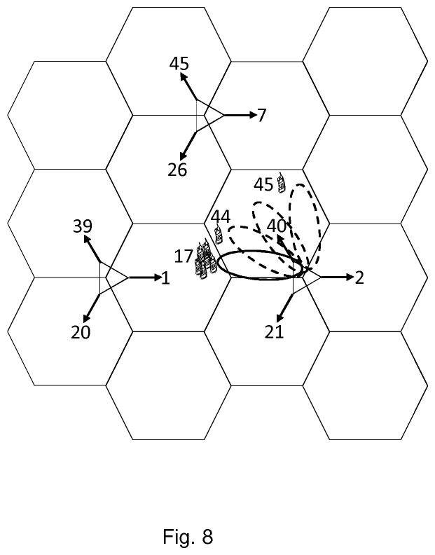

FIG. 8 gives an example for protecting the uplink. Similarly as for FIG. 7, it is assumed that the uplink of the cell edge users 17 of cell 1 is to be protected. It is assumed that one or more time/frequency resources are identified in which the uplink shall be protected. Cell 40 is identified to be the aggressor.

Similarly to the protection of the downlink, the CU-CP may decide the following scheduler restrictions for the identified time/frequency resources:
U1: None of the neighbor cells shall use the uplink (note that uplink interference is induced at the base station, so all surrounding UEs will create uplink interference)
   same constraint as D2
U2: None of the neighbor cells shall schedule the uplink for users which are close to cell 1
   similar constraint as D4
U3: selected neighbor cells (e.g. 21, 40, 26) shall not transmit the downlink at all
   Same constraint as D1
U4: selected neighbors (e.g. 21, 40, 26) shall not use downlink beams towards the direction of base station 1
   This constraint is similar to constraint D1. Taking a closer look, this constraint is weaker, since in the uplink case, only the direction of the base station has to be protected, whereas D1 protects the whole width of the boundary. Some example embodiments of the invention may exploit this additional degree of freedom. However, in some example embodiments of the invention, D1 and U4 may be summarized as one single constraint for simplification.

Finally, let us assume that cell 1 uses beamforming, i.e. all cell edge UEs 17 are served by a narrow beam. This may lead to the same scheduler restrictions as above, but the scheduler restrictions would be sent to a lower number of neighbors, most likely only to cell 40. The impact of other neighbors gets additional attenuation by the applied beam pattern.

The details of the ICIC decision-making are not essential for the invention. These methods may be vendor specific. With the examples, the feasibility of the method is demonstrated. There may be simple methods, but there may also be more advanced and more complicated methods, which may also achieve better performance in some cases.

In the following, signalling according to some example embodiments of the invention will be explained:

Similar to the CoMP Hypothesis Sets for the eCoMP (cf. 3GPP TS 36.423 (X2 specification)), the scheduler restrictions (or more generally: scheduler mode indications) are signalled using a matrix structure, which have time units in the columns and frequency units in the rows (or vice versa). In the following we may call such matrix “scheduler restriction matrix” (SRM) if the scheduler mode indications are scheduler restrictions.

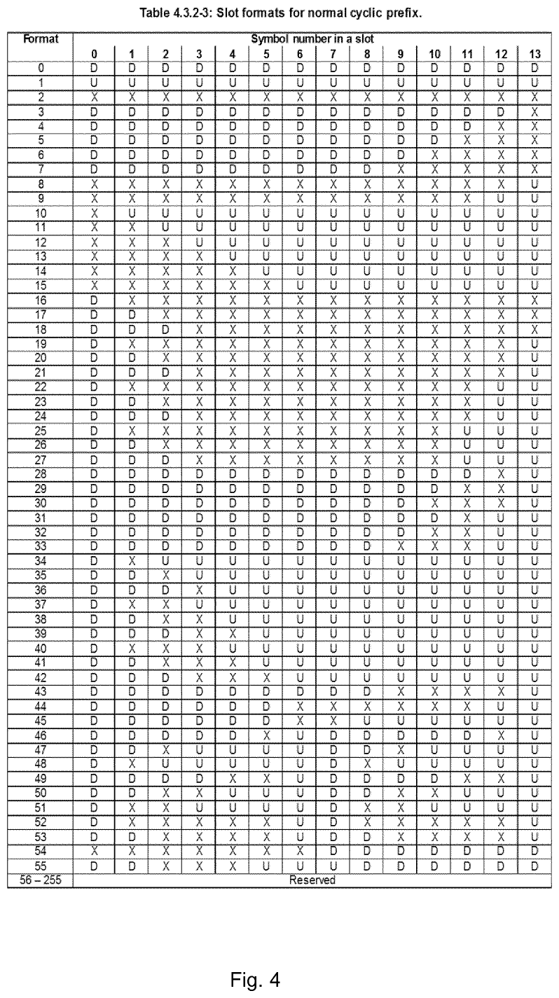

Frequency units may be any type of frequency chunks such as subcarriers, physical resource blocks (PRBs, i.e. a group of subcarriers), or any other group of subcarriers. Time units may be subframes, slots, mini-slots, or OFDM symbols (see 3GPP TS 38.211), depending e.g. on implementation. Note that the frequency units and time units do not necessarily have to be aligned with the slot formats provided in the table of FIG. 4, but it is helpful if the CU-CP takes the slot format into account when making the ICIC decisions (or vice versa).

In a special case, where only frequency coordination is to be provided, the scheduler restriction matrix will only have one column. In a special case, where only time coordination is to be provided, the scheduler restriction matrix will only have one row.

Every entry of the matrix represents one of the scheduler restrictions or a combination thereof, as discussed above. For example, at least one entry of the scheduler restriction matrix may provide to cell B (the aggressor) one of the following scheduler restrictions for a specified resource:
1. Do not use the uplink at all
2. Do not use the downlink at all
3. Do not schedule UEs which are close to boundary towards cell B only or a portion thereof
4. Do not use downlink beams towards boundary towards cell B or a portion thereof
5. Do not use downlink beams towards the direction of base station B (In some example embodiments of the invention, this constraint might be summarized with the previous one for simplification)

In the following, two options to signal the scheduling mode indications are explained at greater detail. The options are explained with respect to scheduling restrictions but they may be applied to scheduling preferences, too.

Option 1: Global SRM and a Set of Cell-Specific SRM

According to option 1, a set of SRM is sent to every cell:
A global SRM: the entries contain 2 bits
   One (e.g. the first) represents whether the downlink can be used
   One (e.g. the second) represents whether the uplink can be used
Optionally one or multiple additional SRMs per boundary (i.e. per neighbor cell): the entries contain 2 bits as well:
   One (e.g. the first) represents whether downlink can be used towards the corresponding neighbor
   One (e.g. the second) represents whether the uplink can be scheduled of UEs which are close to the corresponding neighbor.

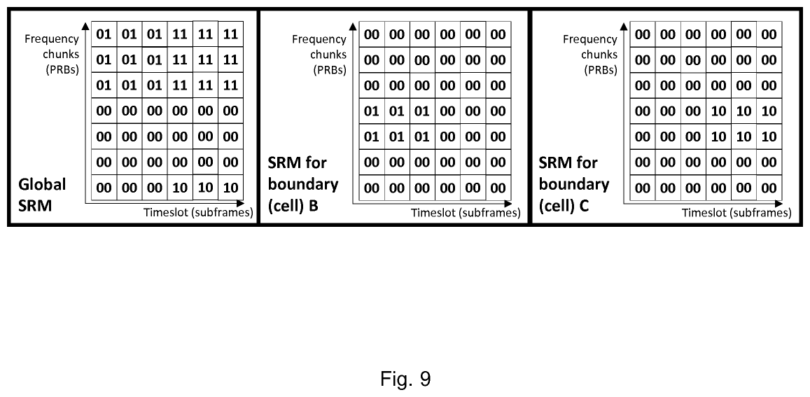

FIG. 9 illustrates option 1 by help of an example, where a given target cell A receives scheduler restrictions from its CU in the format of 3 SRMs. In the example, “0” means “no constraint”, and 1 means “constraint”. The matrices of FIG. 9 are explained in the following:
In the global SRM (left),
   the entries “01” indicate that the cell shall not use the uplink at all on those resources (i.e. blanking).
   the entries “10” indicate that the cell shall not use the downlink at all on those resources (i.e. blanking).
   the entries “11” indicate that the cell shall neither use uplink nor downlink at all on those resources (i.e. blanking).
In the SRM for boundary B (i.e. for users close to the boundary to cell B) (middle in FIG. 9), the entries “01” indicate that the cell shall not schedule the uplink for users which are close to boundary B
   For the sake of completeness, a cell ID (e.g. the ECGI) may be delivered along with each cell-specific SRM (“B” in this case).
In the SRM for boundary C (i.e. for users close to the boundary to cell B) (right in FIG. 9), the entries “10” indicate that the cell shall not send the downlink towards the direction of boundary C
   For the sake of completeness, the cell ID (e.g. the ECGI) may be delivered along with each cell-specific SRM (“C” in this case).

The cell A receiving these SRMs shall consider all those scheduling constraints at the same time.

Option 2: Single SRM with Index to a Restriction List

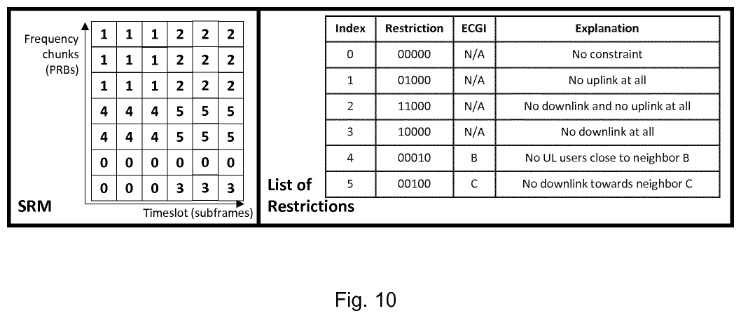

The second option is explained using the same example as in FIG. 9, i.e. the same scheduler restrictions are signalled but with different format (see FIG. 10). According to option 2:
only a single SRM is sent which contains an index to a scheduler restriction which is defined separately. For instance, using a 4 bit index would allow to signal 16 different scheduler restrictions.
The scheduler restrictions themselves are defined in a list of restrictions which contains
   The index
   The restriction: this could again be a bit string, one bit for each of the constraints mentioned above (in the example, 5 bits are shown which would also allow to signal the special case for BS-BS interference as discussed above, i.e. this approach is more flexible than the option 1 example); and
   ECGI (or another cell identifier) which identifies the neighbor cell the restriction is valid for (this is not needed for all constraints).

For both signalling options, the scheduler of the cell receiving the restrictions shall take those constraints into account.

In addition to the scheduler restrictions that the scheduler of the cell shall obey, it might be helpful to inform the cells where they can expect interference protected resources. In some example embodiments of the invention, such signalling is not employed since the channel quality measurements would reflect the better signal-to-interference-ratios. But knowledge of the protected resources may simplify scheduling for the DU. Thus, the CU-CP may send scheduler preferences as well.

Preferably, CU-CP may use the same matrix format as used for the restrictions, but it may use another matrix format, too. In the following, a matrix comprising scheduler preferences (i.e. indications of resources protected in neighbour cells) may be sometimes called “scheduler preference matrix” (SPM). In contrast to the SRM, the SPMs may not be binding, they are only a recommendation. It is up to the schedulers in the DU how to make use of the SPMs. Some of the options for the SPMs are the following:
One SPM per UE or list of UEs, i.e. one matrix is delivered for every critical UE (or list of UEs) which indicates with 1 bit per time/frequency resource, whether it shall be preferred or not. So the CU signals pairs of
   (list of) UE identifiers
   and an SPM for this (list of) UEs.
Separate SPM for critical cell boundaries. Thus, the cell is informed, which resources are protected from interference of a certain neighbor. As a reaction, the scheduler may schedule UEs which are on this cell boundary with this resource. In this case the CU may signal pairs of
   Cell ID (e.g. ECGI) of a critical neighbor
   And SPM for UEs which are close to this neighbor.
In some example embodiments, separate SPMs for uplink and downlink may be used. However, in some example embodiments, only 1 SPM may be used for both uplink and downlink.

In order to distinguish a SRM from a SPM, in some example embodiments, a corresponding tag is sent along with the respective SRM and SPM, respectively.

In some alternative example embodiments, the CU may use only scheduler preference matrices (SPMs) and no scheduler restriction matrices (SRMs) at all. For every critical user group, the CU signals a resource matrix indicating where the groups should be scheduled. “Critical user groups” are user groups which
either need special interference protection (i.e. victims), and therefore should be scheduled at certain resources
or which are creating malicious interference to others (i.e. aggressors), and therefore should be scheduled on resources which do not harm sensitive victims.

In these example embodiments, the scheduler has to obey the SPM for the critical user groups. I.e., the scheduler must not schedule any resource for the critical user group which is not allowed by a SPM.

In some example embodiments, where the CU is split by an E1 interface into CU-CP and CU-UP, the CU-CP may extend its knowledge for better ICIC decisions with QoS information which is signalled from CU-UP via E1 interface. QoS information may comprise:
Buffer Status Information
Throughput measurements from the past

Such an information is helpful to make the ICIC decisions, in particular it indicates how “heavy” the users are, i.e. how many interference protected resources should be created, and how interference protected they have to be.

Furthermore, in some example embodiments, the CU-CP may extend its knowledge for better ICIC decisions with additional radio information which is signalled from DU via F1-C. Additional radio information may comprise:
Frequency resolved uplink interference measurements
Instantaneous and frequency resolved Channel State Information (e.g. CQI)
Channel State Information averaged over frequency and/or time.

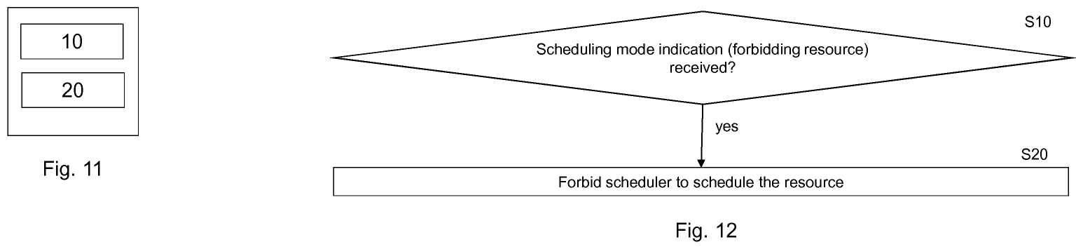

FIG. 11 shows an apparatus according to an example embodiment of the invention. The apparatus may be a control unit which may be implemented in base station (e.g. gNB) or a DU or a cell or an element thereof. FIG. 12 shows a method according to an example embodiment of the invention. The apparatus according to FIG. 11 may perform the method of FIG. 12 but is not limited to this method. The method of FIG. 12 may be performed by the apparatus of FIG. 11 but is not limited to being performed by this apparatus.

The apparatus comprises means for monitoring 10 and means for forbidding 20. The means for monitoring 10 and means for forbidding 20 may be a monitoring means and forbidding means, respectively. The means for monitoring 10 and means for forbidding 20 may be a monitor and a forbidder, respectively. The means for monitoring 10 and means for forbidding 20 may be a monitoring processor and forbidding processor, respectively.

The means for monitoring 10 monitors if a first cell receives one or more scheduling mode indications including a first scheduling mode indication (S10). The scheduling mode indications are for at least one of a downlink transmission of the first cell and an uplink transmission to the first cell. The first scheduling mode indication comprises forbidding to schedule a respective resource for the at least one of the downlink transmission and the uplink transmission. A resource may be a frequency chunk at a recurring time instance, a frequency chunk (for all instances of the recurring time instances), or a recurring time instance (for all frequency chunks).

If the one or more scheduling mode indications are received (S10=“yes”), the means for forbidding 20 forbids, for the first scheduling mode indication, a scheduler of the first cell to schedule the respective resource (i.e., the resource indicated in the first scheduling mode indication) for the at least one of the downlink transmission and the uplink transmission (S20).

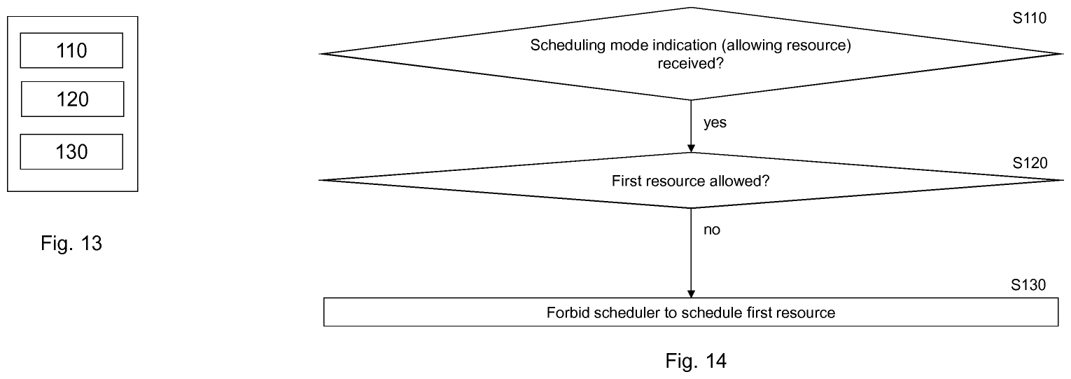

FIG. 13 shows an apparatus according to an example embodiment of the invention. The apparatus may be a control unit which may be implemented in base station (e.g. gNB) or a DU or a cell or an element thereof. FIG. 14 shows a method according to an example embodiment of the invention. The apparatus according to FIG. 13 may perform the method of FIG. 14 but is not limited to this method. The method of FIG. 14 may be performed by the apparatus of FIG. 13 but is not limited to being performed by this apparatus.

The apparatus comprises means for monitoring 110, means for checking 120, and means for forbidding 130. The means for monitoring 110, means for checking 120, and means for forbidding 130 may be a monitoring means, checking means, and forbidding means, respectively. The means for monitoring 110, means for checking 120, and means for forbidding 130 may be a monitor, a checker, and a forbidder, respectively. The means for monitoring 110, means for checking 120, and means for forbidding 130 may be a monitoring processor, a checking processor, and a forbidding processor, respectively.

If the first cell receives the one or more scheduling mode indications (S110=“yes”), the means for checking 120 checks if at least one of the one or more scheduling mode indications allows to schedule a first resource for the at least one of the downlink transmission and the uplink transmission (S120). A resource may be a frequency chunk at a recurring time instance, a frequency chunk (for all instances of the recurring time instances), or a recurring time instance (for all frequency chunks).

If none of the one or more scheduling mode indications allows to schedule the first resource for the at least one of the downlink transmission and the uplink transmission (S120=“no”), the means for forbidding forbid a scheduler of the first cell to schedule the first resource for the at least one of the downlink transmission and the uplink transmission.

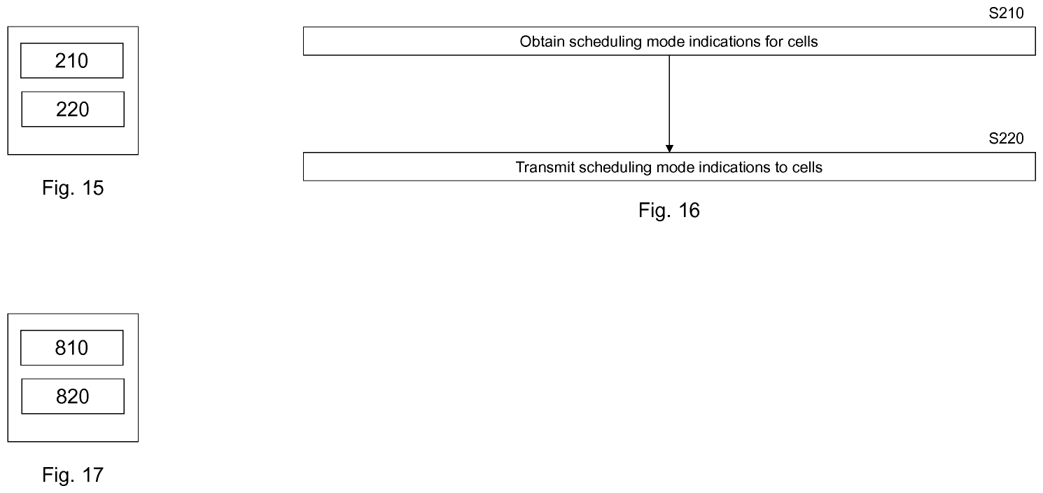

FIG. 15 shows an apparatus according to an example embodiment of the invention. The apparatus may be a control unit which may be implemented in base station (e.g. gNB) or a CU or a cell or an element thereof. FIG. 16 shows a method according to an example embodiment of the invention. The apparatus according to FIG. 15 may perform the method of FIG. 16 but is not limited to this method. The method of FIG. 16 may be performed by the apparatus of FIG. 15 but is not limited to being performed by this apparatus.

The apparatus comprises means for obtaining 210 and means for transmitting 220. The means for obtaining 210 and means for transmitting 220 may be an obtaining means and transmitting means, respectively. The means for obtaining 210 and means for transmitting 220 may be an obtainer and a transmitter, respectively. The means for obtaining 210 and means for transmitting 220 may be an obtaining processor and transmitting processor, respectively.

The means for obtaining 210 obtains for each of one or more cells respective one or more scheduling mode indications including a respective first scheduling mode indication (S210). The one or more scheduling mode indications are for at least a respective one of a downlink transmission of the respective cell and an uplink transmission to the respective cell. Each of the first scheduling mode indications comprises either forbidding to schedule a respective resource for the at least one of the downlink transmission of the respective cell and the uplink transmission to the respective cell or allowing to schedule the respective resource for the at least one of the downlink transmission of the respective cell and the uplink transmission to the respective cell. A resource may be a frequency chunk at a recurring time instance, a frequency chunk (for all instances of the recurring time instances), or a recurring time instance (for all frequency chunks). The means for obtaining may obtain the one or more scheduling mode indications from a decision device configured to decide on scheduling restrictions and preferences for the one or more cells.

The means for transmitting 220 transmits, for each of the one or more cells, the respective one or more scheduling mode indications to the respective cell.

FIG. 17 shows an apparatus according to an example embodiment of the invention. The apparatus comprises at least one processor 810, at least one memory 820 including computer program code, and the at least one processor 810, with the at least one memory 820 and the computer program code, being arranged to cause the apparatus to at least perform at least one of the methods according to FIGS. 12, 14, and 16.

Some example embodiments of the invention are described which are based on a 3GPP network (e.g. E-UTRAN or NR). However, the invention is not limited to 3GPP networks. It may be applied to other radio networks with intercell interference coordination or mitigation.

A UE is an example of a terminal. However, the terminal (UE) may be any device capable to connect to the radio network such as a MTC device, a D2X device etc.

A cell may be represented by the base station serving the cell. The base station (cell) may be connected to the antenna (array) serving the cell by a Remote Radio Head. Some example embodiments of the invention (in particular those related to DU) may be deployed in the Remote Radio Head.

One piece of information may be transmitted in one or plural messages from one entity to another entity. Each of these messages may comprise further (different) pieces of information.

A matrix is a particular type of a data structure. The scheduling mode indications may be provide in any other data structure. For example, they may be linearly arranged, or the scheduling mode indications may not be ordered but each scheduling mode indication comprises a tag indicating the restricted frequency and recurring time instance.

Names of network elements, protocols, and methods are based on current standards. In other versions or other technologies, the names of these network elements and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software.

That is, each of the entities described in the present description may be based on different software, or some or all of the entities may be based on the same software. Each of the entities described in the present description may be embodied in the cloud.

According to the above description, it should thus be apparent that example embodiments of the present invention provide, for example, a base station (e.g. a gNB or eNB,) or a cell thereof, or a component thereof (such as a CU or a DU), an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof.

It is to be understood that what is described above is what is presently considered the preferred example embodiments of the present invention. However, it should be noted that the description of the preferred example embodiments is given by way of example only and that various modifications may be made without departing from the scope of the invention as defined by the appended claims.

1-28. (canceled)

29. Apparatus comprising:
at least one processor and at least one memory including a computer program code, and the at least one processor, with the at least one memory and the computer code being arranged to cause the apparatus at least to:
monitor if a first cell receives one or more scheduling mode indications including a first scheduling mode indication for at least one of a downlink transmission of the first cell and an uplink transmission to the first cell, wherein the first scheduling mode indication comprises forbidding to schedule a respective resource for the at least one of the downlink transmission and the uplink transmission; and
forbid, for the first scheduling mode indication, a scheduler of the first cell to schedule the respective resource for the at least one of the downlink transmission and the uplink transmission if the one or more scheduling mode indications are received.

30. The apparatus according to claim 29, and the at least one processor, with the at least one memory and the computer code being further arranged to cause the apparatus to:
monitor if a first cell receives more than one scheduling mode indications including a second scheduling mode indication for the at least one of the downlink transmission and the uplink transmission, wherein the second scheduling mode indication comprises at least one of allowing to schedule the respective resource, and recommending to schedule the respective resource; and
inform the scheduler that the respective resource is allowed and recommendable, respectively, for the at least one of the downlink transmission and the uplink transmission if the first cell receives the second scheduling mode indication.

31. The apparatus according to claim 29, and the at least one processor, with the at least one memory and the computer code being further arranged to cause the apparatus to:
monitor if the cell receives a notification along with the one or more scheduling mode indications, wherein the notification notifies at least one of the following dedications:
the one or more scheduling mode indications are for the uplink transmission only;
the one or more scheduling mode indications are for the downlink transmission only;
the one or more scheduling mode indications are for the uplink transmission and for the downlink transmission;
the one or more scheduling mode indications are related to terminals at an entire cell boundary of the first cell only;
the one or more scheduling mode indications are related to uplink transmissions of terminals located at the cell boundary of the first cell towards a second cell only or a portion thereof, wherein the notification comprises an identification of the second cell; and
the one or more scheduling mode indications are related to downlink transmissions towards the direction of the cell boundary of the first cell towards a second cell only or a portion thereof, wherein the notification comprises an identification of the second cell; and
forbid, for each of the one or more scheduling mode indications, the scheduler to schedule the respective resource according to the at least one of the dedications if the at least one of the dedications is received.

32. The apparatus according to claim 29, wherein at least one of the scheduling mode indications comprises a link to a table comprising a meaning of the respective scheduling mode indication.

33. Apparatus comprising:
at least one processor and at least one memory including a computer program code, and the at least one processor, with the at least one memory and the computer code being arranged to cause the apparatus at least to
monitor if a first cell receives one or more scheduling mode indications for at least one of a downlink transmission of the first cell and an uplink transmission to the first cell, wherein each of the one or more scheduling mode indications comprise allowing to schedule a respective resource for the at least one of the downlink transmission and the uplink transmission; and
check if at least one of the one or more scheduling mode indications allows to schedule a first resource for the at least one of the downlink transmission and the uplink transmission if the first cell receives the one or more scheduling mode indications; and
forbid a scheduler of the first cell to schedule the first resource for the at least one of the downlink transmission and the uplink transmission if none of the one or more scheduling mode indications allows to schedule the first resource for the at least one of the downlink transmission and the uplink transmission.

34. The apparatus according to claim 33, and the at least one processor, with the at least one memory and the computer code being further arranged to cause the apparatus to:
monitor if the cell receives a notification along with the one or more scheduling mode indications, wherein the notification notifies at least one of the following dedications:
the one or more scheduling mode indications are for the uplink transmission only;
the one or more scheduling mode indications are for the downlink transmission only;
the one or more scheduling mode indications are for the uplink transmission and for the downlink transmission;
the one or more scheduling mode indications are related to terminals at an entire cell boundary of the first cell only;
the one or more scheduling mode indications are related to uplink transmissions of terminals located at the cell boundary of the first cell towards a second cell only or a portion thereof, wherein the notification comprises an identification of the second cell; and
the one or more scheduling mode indications are related to downlink transmissions towards the direction of the cell boundary of the first cell towards a second cell only or a portion thereof, wherein the notification comprises an identification of the second cell; and
forbid, for each of the one or more scheduling mode indications, the scheduler to schedule the respective resource according to the at least one of the dedications if the at least one of the dedications is received.

35. The apparatus according to claim 33, wherein at least one of the scheduling mode indications comprises a link to a table comprising a meaning of the respective scheduling mode indication.

36. Apparatus comprising:
at least one processor and at least one memory including a computer program code, and the at least one processor, with the at least one memory and the computer code being arranged to cause the apparatus at least to:
obtain for each of one or more cells for at least a respective one of a downlink transmission of the respective cell and an uplink transmission to the respective cell respective one or more scheduling mode indications including a respective first scheduling mode indication; wherein each of the first scheduling mode indications comprises either forbidding or allowing to schedule a respective resource for the at least one of the downlink transmission of the respective cell and the uplink transmission to the respective cell; and
transmit, for each of the one or more cells, the respective one or more scheduling mode indications to the respective cell.

37. The apparatus according to claim 36, and the at least one processor, with the at least one memory and the computer code being further arranged to cause the apparatus to:
obtain, for at least one of the one or more cells, more than one respective scheduling mode indications including a respective second scheduling mode indication for the respective at least one of the downlink transmission of the respective cell and the uplink transmission to the respective cell;
the respective first scheduling mode indication for the at least one of the one or more cells comprises forbidding to schedule the respective resource for the at least one of the downlink transmission of the respective cell and the uplink transmission to the respective cell;
each of the second scheduling mode indications comprises at least one of allowing to schedule the respective resource, and recommending to schedule the respective resource for the respective at least one of the downlink transmission of the respective cell and the uplink transmission to the respective cell.

38. The apparatus according to claim 36, and the at least one processor, with the at least one memory and the computer code being further arranged to cause the apparatus to:
transmit, for at least one of the one or more cells, a respective notification along with the one or more scheduling mode indications, wherein each of the notifications notifies at least one of the following dedications:
the respective one or more scheduling mode indications are for the respective uplink transmission only;
the respective one or more scheduling mode indications are for the respective downlink transmission only;
the respective one or more scheduling mode indications are for the respective uplink transmission and for the respective downlink transmission;
the respective one or more scheduling mode indications are related to terminals at an entire cell boundary of the respective cell only;
the one or more scheduling mode indications are related to uplink transmissions of terminals located at the cell boundary of the first cell towards a second cell only or a portion thereof, wherein the notification comprises an identification of the second cell; and
the one or more scheduling mode indications are related to downlink transmissions towards the direction of the cell boundary of the first cell towards a second cell only or a portion thereof, wherein the notification comprises an identification of the second cell.

39. The apparatus according claim 36, wherein at least one of the scheduling mode indications comprises a link to a table comprising a meaning of the respective scheduling mode indication.

40. The apparatus according to claim 36, and the at least one processor, with the at least one memory and the computer code being further arranged to cause the apparatus to:
obtain for each of more than one cells the respective one or more scheduling mode indications; and jointly determine the respective one or more scheduling mode indications for each of the more than one cells; wherein the respective one or more scheduling mode indications for the more than one cells are obtained from a coordination entity.

41. The apparatus according to claim 36, and the at least one processor, with the at least one memory and the computer code being further arranged to cause the apparatus to:
perform coordination to provide the one or more scheduling mode indications based on at least one of a
information from radio resource control of the one or more cells;
quality of service information of a terminal served by one of the one or more scheduling mode indications;
frequency resolved uplink interference measurements of at least one of the one or more cells;
channel state information of at least one of the one or more cells;
wherein the one or more scheduling mode indications are obtained based on the coordination.

42. Method, comprising
obtaining for each of one or more cells for at least a respective one of a downlink transmission of the respective cell and an uplink transmission to the respective cell respective one or more scheduling mode indications including a respective first scheduling mode indication; wherein each of the first scheduling mode indications comprises either forbidding or allowing to schedule a respective resource for the at least one of the downlink transmission of the respective cell and the uplink transmission to the respective cell; and
the method further comprises
transmitting, for each of the one or more cells, the respective one or more scheduling mode indications to the respective cell.

43. The method according to claim 42, wherein
the obtaining comprises obtaining, for at least one of the one or more cells, more than one respective scheduling mode indications including a respective second scheduling mode indication for the respective at least one of the downlink transmission of the respective cell and the uplink transmission to the respective cell;
the respective first scheduling mode indication for the at least one of the one or more cells comprises forbidding to schedule the respective resource for the at least one of the downlink transmission of the respective cell and the uplink transmission to the respective cell;
each of the second scheduling mode indications comprises at least one of allowing to schedule the respective resource, and recommending to schedule the respective resource for the respective at least one of the downlink transmission of the respective cell and the uplink transmission to the respective cell.

44. The method according to claim 42, wherein the transmitting additionally comprises transmitting, for at least one of the one or more cells, a respective notification along with the one or more scheduling mode indications, wherein each of the notifications notifies at least one of the following dedications:
the respective one or more scheduling mode indications are for the respective uplink transmission only;
the respective one or more scheduling mode indications are for the respective downlink transmission only;
the respective one or more scheduling mode indications are for the respective uplink transmission and for the respective downlink transmission;
the respective one or more scheduling mode indications are related to terminals at an entire cell boundary of the respective cell only;
the one or more scheduling mode indications are related to uplink transmissions of terminals located at the cell boundary of the first cell towards a second cell only or a portion thereof, wherein the notification comprises an identification of the second cell; and
the one or more scheduling mode indications are related to downlink transmissions towards the direction of the cell boundary of the first cell towards a second cell only or a portion thereof, wherein the notification comprises an identification of the second cell.

45. The method according to claim 42, wherein at least one of the scheduling mode indications comprises a link to a table comprising a meaning of the respective scheduling mode indication.

46. The method according to claim 42, wherein
the obtaining comprises obtaining for each of more than one cells the respective one or more scheduling mode indications; and
the method further comprises
jointly determining the respective one or more scheduling mode indications for each of the more than one cells; wherein
the obtaining comprises obtaining the respective one or more scheduling mode indications for the more than one cells from a coordination entity.

47. The method according to claim 42, further comprising
providing the one or more scheduling mode indications based on at least one of a
information from radio resource control of the one or more cells;
quality of service information of a terminal served by one of the one or more scheduling mode indications;
frequency resolved uplink interference measurements of at least one of the one or more cells;
channel state information of at least one of the one or more cells;
wherein the obtaining comprises obtaining the provided one or more scheduling mode indications.

48. A non-transitory computer readable medium storing a program of instructions which, when executed on an apparatus, cause the apparatus to carry out the method according to claim 42.
